(19) United States
(12) Patent Application Publication
(10) Pub. No.: US 2026/0368280 A1
(43) Pub. Date: Nov. 19, 2026

(54) CLASSIFYING WRITING CONTENT USING A HYBRID LANGUAGE MODEL AND CLASSIFICATION MODEL FRAMEWORK

(71) Applicant: Bold Limited, Hamilton (BM)

(72) Inventors: Kai JIN, Davis, CA (US); Wendy YOUNG, Louisville, TN (US); Suchi JINDAL, Agra (IN); Mohit Kumar GOEL, Greater Noida (IN)

(21) Appl. No.: 19/206,146

(22) Filed: May 13, 2025

(51) Int. Cl. G06F 18/241

(52) U.S. Cl. CPC G06F 18/241

(57) ABSTRACT

Certain aspects of the disclosure provide a method for classifying writing content excerpts. In aspects, the method includes receiving a set of writing content excerpts; receiving from a language model a first set of refined content groupings, each refined content grouping of the first set of refined content groupings comprising one or more writing content excerpts labeled with one of a relevant label or an irrelevant label; creating, for each refined content grouping a set of writing content excerpt pairs; extracting a set of linguistic features from each writing content excerpt pair; providing the set of writing content excerpt pairs, the first set of refined content groupings, and the extracted set of linguistic features for each writing content excerpt pair to a decision tree-based classification model; and processing each writing content excerpt pair with the decision tree-based classification model to generate a second refined set of content groupings.

### TECHNICAL FIELD

Aspects of the present disclosure relate to methods for classifying writing content using a hybrid language model and classification model framework.

### BACKGROUND

Organizations use various systems and techniques to classify writing content. Accurate classification is useful for managing large volumes of writing content to support a variety of tasks such as content delivery, sentiment analysis, and content moderation. For example, an organization may classify writing content derived from customer reviews to support a comprehensive analysis that provides the organization with insights usable to improve decision-making and enhance user experiences. Improved techniques for classifying writing content are desirable for promoting increased accuracy, efficiency, and scalability in managing large volumes of writing content to support performance of different related tasks.

### SUMMARY

A first aspect provides a method for classifying writing content excerpts, the method including: receiving a set of writing content excerpts and an associated topic; providing to a language model the set of writing content excerpts and a first prompt configured to cause the language model to generate an initial set of content groupings categorizing each writing content excerpt of the set of writing content excerpts based on the associated topic; receiving from the language model the initial set of content groupings; providing to the language model the initial set of content groupings and a second prompt configured to cause the language model to perform few-shot filtering to generate a set of labeled writing content excerpts based on the initial set of content groupings; receiving from the language model a first set of refined content groupings, each refined content grouping of the first set of refined content groupings comprising one or more writing content excerpts labeled with one of a relevant label or an irrelevant label; creating, for each refined content grouping of the first refined set of content groupings, a set of writing content excerpt pairs; extracting a set of linguistic features from each writing content excerpt pair of the set of writing content excerpt pairs; providing the set of writing content excerpt pairs, the first set of refined content groupings, and the extracted set of linguistic features for each writing content excerpt pair to a decision tree-based classification model; and processing each writing content excerpt pair of the set of writing content excerpt pairs with the decision tree-based classification model to generate a second refined set of content groupings based on the first set of refined content groupings and the extracted set of linguistic features for each writing content excerpt pair.

A second aspect provides a method including: receiving a set of writing content excerpts and an associated topic; providing to a language model the set of writing content excerpts and a first prompt configured to cause the language model to generate an initial set of content groupings categorizing each writing content excerpt of the set of writing content excerpts based on the associated topic; receiving from the language model the initial set of content groupings; providing to the language model the initial set of content groupings and a second prompt configured to cause the language model to perform few-shot filtering to generate a set of labeled writing content excerpts based on the initial set of content groupings; receiving from the language model a first set of refined content groupings, each refined content grouping of the first set of refined content groupings comprising one or more writing content excerpts labeled with one of a relevant label or an irrelevant label; creating, for each refined content grouping of the first refined set of content groupings, a set of writing content excerpt pairs; extracting a set of linguistic features from each writing content excerpt pair of the set of writing content excerpt pairs; generating a set of training data comprising the first set of refined content groupings, the extracted set of linguistic features for each writing content excerpt pairs, and a set of manually labeled content groupings, wherein the manually labeled content groupings are based on the initial set of content groupings; and training a decision tree-based classification model with the set of training data, wherein the decision tree-based classification model is configured to determine a similarity prediction for input comprising a pair of writing content excerpts.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example environment for implementing an illustrative writing content classification system for classifying writing content using a hybrid language model and classification model framework according to one or more aspects.

FIG. 2 depicts an example process of training a decision tree-based model implementable by a writing content classification system for classifying writing content using a hybrid language model and classification model framework according to one or more aspects.

FIG. 3 depicts a table including example pairwise writing content excerpts that have been manually labeled for incorporating into a training dataset usable to train a decision tree-based model implementable by a writing content classification system according to one or more aspects.

FIG. 4 depicts an example process implementable by a writing content classification system for classifying writing content using a hybrid language model and classification model framework according to one or more aspects.

FIG. 5 depicts a table including example labeled writing content excerpts obtainable by illustrative few-shot filtering techniques implementable by a language model of a writing content classification system according to one or more aspects.

FIG. 6 depicts a table including example test data that may be processed using a decision tree-based model of a writing content classification system according to one or more aspects.

FIG. 7 depicts a table comparing classification performance of different classification frameworks with a hybrid language model and decision tree-based framework implementable by a writing content classification system according to one or more aspects.

FIG. 8 depicts an example method for classifying writing content using a hybrid language model and classification model framework according to one or more aspects.

FIG. 9 depicts an example processing system for enabling a writing content classification system for classifying writing content using a hybrid language model and classification model framework according to one or more aspects.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for classifying writing content using a hybrid classification framework. As used herein a “hybrid classification framework” refers to a classification system that employs both a classification model and language model-based techniques. The employed classification model is configured to consider a combination of features derived from language model-based techniques and extracted linguistic features that are each associated with received writing content excerpts to be classified. For example, writing content excerpts may be classified into groupings including sets of writing content excerpts having similar meaning. While some aspects herein generally relate to example hybrid classification frameworks that employ a random forest classification model, other aspects in accordance with systems described herein may instead utilize other tree-based models for classification, such as gradient boosting trees (GBT), extremely randomized trees (ERT), rotation forests, oblique trees, or other decision tree-based classifiers. In other aspects, the classification model implemented by the writing content classification system may include various types of linear models (e.g. support vector machines), neural networks, probabilistic models, instance-based learning models (e.g. k-Nearest Neighbors based models), stacked generalization models, graph-based models, or any other type of machine learning models or techniques useful for classifying writing content into groupings, Described writing content classification systems are further configured to utilize language models for refining writing content groupings. For example, the writing content classification system first provides a language model with a first prompt to cause the language model to return initial content groupings for received writing content excerpts. The language model is then provided with a second prompt configured to cause the language model to perform few-shot filtering to validate the initial content groupings and generate a first refined set of content groupings, including writing content excerpts labeled with binary features (e.g. relevant or irrelevant to an initial content grouping for a writing excerpt). Described writing content classification systems then utilize algorithms to extract a set of linguistic features from pairs of writing content excerpts that are derived from the returned initial content groupings. An employed classification model is configured to then leverage both the labeled writing content excerpts from the language model-based few-shot filtering and the extracted linguistic features to generate a second refined set of content groupings for accurately classifying input writing content excerpts.

Certain conventional techniques for classifying writing content use word matching algorithms. For example, certain lexical matching algorithms rely upon exact or partial word matching for grouping sentences based on overlapping words between sentences, by calculating cosine similarity between word frequency vectors, or by calculating an edit distance (e.g. Levenshtein distance) to measure how many insertions, deletions or substitutions are needed to transform one sentence into another. However, word matching algorithms only detect duplicate content based on exact word matches, missing out on the broader spectrum of content that is functionally similar but uses varied language. For example, word matching algorithms may fail to accurately group sentences using synonyms, paraphrasing, or varied phrasing for writing content excerpts that convey similar meaning despite minor differences in language.

Other conventional techniques for classifying writing content use clustering algorithms to group content based on semantic similarity. However, clustering techniques often group non-similar content together due to the limitations of semantic distance measures and, for example, an arbitrary number of clusters. For example, a clustering algorithm may group a first sentence stating “Implemented inventory control measures, reducing food waste and minimizing operational costs” with a second sentence stating “Managed food costs, sourcing ingredients from local suppliers to support community partnerships and sustainable practices” based on incorrectly assuming that the tasks are similar based on shared semantic features or words in each sentence. These challenges are further exacerbated when grouping writing content related to resumes or professional experience, as this writing content is often specific to certain job titles or job responsibility descriptions, thereby amplifying the inability of general semantic models to account for contextual nuances, leading to decreased precision and efficiency based on inaccurately grouping writing content excerpts that have distinct meaning or ideas. Although the examples provided herein are in the domain of career documentation (e.g., resumes, cover letters, and the like), content classification techniques and systems disclosed herein may be utilized with content generation related to any domain.

More recently, few-shot learning techniques involving prompting language models to classify writing content have been employed. However, few-shot learning techniques for grouping writing content that use language models often result in increased numbers of false positives in which sentences are incorrectly grouped together despite having different meaning or unrelated content. This is because language models often experience difficulties excluding unique or irrelevant content from a set of established groups, particularly when relying on limited quantities of positive and negative examples. Certain language models are also trained or designed to be biased towards inclusion rather than exclusion, which increases the rate of false positives when grouping writing content, thereby decreasing classification accuracy.

Aspects described herein provide a technical solution for the aforementioned technical problems by providing systems and methods utilizing a hybrid classification framework for classifying writing content excerpts. In particular, described writing content classification systems leverage language model-driven prompt engineering to generate initial content groupings to group similar writing content based on contextual information such as one or more of associated topics such as job titles, job tasks, or job responsibilities. Utilizing prompts including contextual information overcomes the shortcomings of classification methods relying on semantic similarity or clustering that fail to account for contextual nuances. The writing content classification systems described herein further utilize a second prompt configured to cause the language model to perform few-shot filtering to label writing content excerpts of the initial content groupings with binary features indicating whether each writing excerpt is relevant or not relevant with respect to a corresponding initial content grouping. The labeled writing content excerpts are then utilized by a classification model to enhance precision in further refining the groupings during classification of input writing content excerpts.

Writing content classification systems described herein further employ algorithms for extracting sets of linguistic features for writing content excerpt pairs derived from a set of received writing content excerpts. The extracted linguistic features are then leveraged by the classification model to increase accuracy during classification of writing content, such as by mitigating the false positives associated with relying exclusively on techniques utilizing prompting-based methods. By employing a hybrid framework, described writing content classification systems can use a classification model that processes both labeled writing content excerpts, generated via language model-driven prompting techniques, and a set of linguistic features extracted for each writing content excerpt pair to classify received writing content excerpts. As used herein a “writing content excerpt pair” refers to two distinct writing content excerpts (e.g. two sentences, bullets, phrases, etc.) that described aspects may process to extract one or more linguistic features to facilitate grouping of each writing content excerpt in the pair. The classification models employed by described writing content classification systems therefore consider both contextual information through the use of language model-driven prompting and extracted linguistic features for providing additional lexical similarity context. This reduces language model-based false positives (e.g. sentences grouped together despite differences in meaning) through the use of the classification model that is further informed by extracted linguistic for providing additional lexical-based context.

Described writing content classification systems further provide for various technical benefits. As discussed above, the hybrid framework employed by described writing content classification systems for classifying received writing content excerpts simultaneously reduces inaccurate classifications based on lack of contextual information and redundancy associated with false positives from solely using language model-based techniques. This provides the technical benefit of improving scalability by reducing storage and computational needs associated with handling and processing duplicate, redundant, or inaccurately classified content.

The writing content classification systems described herein further provide the technical benefit of improving performance and accuracy of downstream systems utilizing the classified writing content. For example, described writing content classification systems may provide grouped writing content excerpts to a downstream system responsible for delivering content including a most-relevant unique writing content excerpt in response to a user query. Accordingly, the downstream system relies upon accurately grouped writing content excerpts to ensure it delivers only unique and high-quality content. This becomes increasingly important for systems in which additional writing content excerpts are continuously added, as inaccurate grouping can result in a content delivery system providing redundant or inaccurate content. Accordingly, described writing content classification systems provide increased accuracy in classifying writing content excerpts into groups, thereby providing the technical benefit of increased performance and accuracy of downstream systems that rely on the groupings.

The hybrid framework employed by described writing content classification systems further reduces single-point failures of relying on any given classification technique by enabling redundant decision layers for validating classifications. For example, rather than relying on a singular technique for classification, an employed classification model, such as a decision tree based model, relies on navigating decision trees that consider multiple independent decision factors to predict and validate groupings. For example, the decision tree-based model may utilize decision trees having nodes for considering language-model based grouping labels, while other nodes are usable to consider extracted linguist-features for predicting refined groupings for a pair of writing content excerpts. Accordingly, the redundant decision layers may allow for mitigation of false positives or false negatives produced by preventing reliance on signals associated with any single classification technique from cascading into an inaccurate classification or grouping of writing content. This provides the technical benefit of reducing error propagation and increasing accuracy when classifying writing content excerpts via grouping.

### Example Systems and Methods for Classifying Writing Content

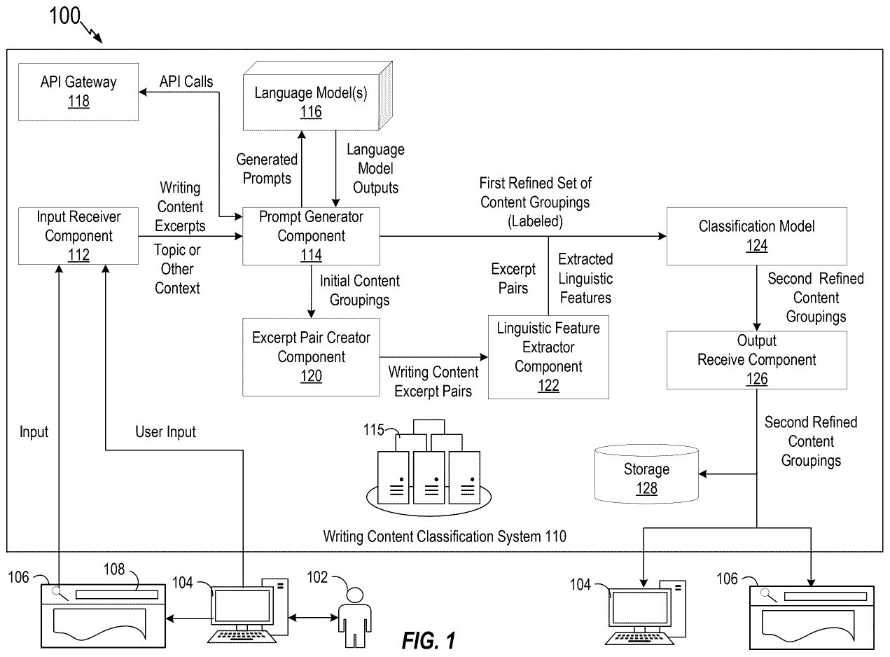

FIG. 1 depicts an example environment 100 for implementing an illustrative writing content classification system 110 for classifying writing content using a hybrid classification framework according to one or more aspects.

Writing content classification system 110 is configured to classify received writing content excerpts into content groupings based on similar content and conveyed meaning. As used herein, “excerpts” refer to one or more of sentences, phrases, paragraphs, bullet points, headings, or any other structure or format usable for organizing writing content. In particular, writing content excerpts received by described aspects may include, but are not limited to, resume experience excerpts, job descriptions, or task descriptions. In certain aspects, writing content classification system 110 performs processes for classifying writing content excerpts using one or more computing devices 115. The one or more computing devices 115 (sometimes referred to as “processing systems”) of writing content classification system 110 may include one or more processors and one or more non-transitory computer-readable mediums (e.g., memories) storing computer-readable instructions that, when executed by the one or more processors, cause the one or more computing devices to perform processes defined by computer-readable instructions corresponding to one or more components depicted and described herein.

Writing content classification system 110 includes an input receiver component 112 that is configured to receive input including writing content excerpts and contextual information. As used herein “contextual information” refers to supplementary details that provide background or clarify a broader framework for understanding a given received writing content excerpt. For example, when used to classify and group writing content excerpts including descriptions of job responsibilities or work experience, writing content classification system 110 may further receive and consider contextual information including a topic associated with the writing content excerpt. As used herein, a “topic” refers to any phrase, word, or title that includes a subject, concept, idea, or theme associated with a given writing content excerpt. In some examples, a topic associated with a writing content excerpt may include a job title or a job task, such as when classifying writing content excerpts for creating or editing professional resumes. In other examples a topic associated with a writing content excerpt may include a category or subject for a given customer support task, such as when classifying writing content excerpts for user queries related to customer support use-cases.

Writing content classification system 110 may be implemented as a standalone application or in conjunction with a web-based application 106 configured to use writing content classification system 110 to classify writing content for enhancing content delivery services. Web-based application 106 may be a platform that enables users to build professional resumes, navigate online job postings, or build professional user profiles. In some examples, web-based application 106 may include a search box 108 for receiving user input (e.g., text strings) from a user 102. The user 102 may interface with the user interface of web-based application 106 via a device 104. In certain aspects, device 104 may be a personal computer, a tablet computer, a smart device (e.g., a smartphone), or the like. User 102 may interact with web-based application 106 to build a resume, where a search box 108 enables user 102 to search for relevant content to include within the resume. Web-based application 106 may utilize writing content classification system 110 to classify received or stored writing content, thereby removing redundant content and increasing both precision and relevance of returned content for user 102. For example, web-based application 106 may provide input including writing content and associated topics to writing content classification system 110 for classifying and grouping of the received inputs, thereby enabling web-based application 106 to ensure that only a single most-relevant writing content excerpt is provided to a user query, while any duplicate writing content excerpts are omitted.

In other examples in which writing content classification system 110 functions as a standalone application. User 102 may manually provide user input including writing content excerpts and contextual information. For example, user 102 may provide writing content classification system 110 with user input including writing content excerpts corresponding to work experience bullets and an associated job title. User 102 may provide the user input by using device 104 to interface with a user interface provided by writing content classification system 110.

Input receiver component 112 may then provide the received writing content and contextual information to a prompt generator component 114 configured to generate prompts for causing one or more language model(s) 116 to generate and return various language model outputs.

A language model is generally a type of machine learning model that is designed to understand, generate, and manipulate human language. More specifically, a language model is a probabilistic framework that determines the likelihood of a sequence of words or tokens. At its core, a language model attempts to predict the probability of the next word in a sentence given the preceding words. The model estimates these probabilities based on the patterns it learned during training. Language models are useful in natural language processing (NLP) and computational linguistics for performing a range of tasks involving human language, such as those described herein.

Language models may be characterized by various components and capabilities. For example, a language model may include a vocabulary that defines the set of all possible words or tokens that the model can recognize and use. This includes common words, punctuation, and possibly domain-specific jargon. Language models may also consider a context, which includes to the preceding words in a sentence or sequence that the model uses to predict the next word. Language models often incorporate extensive context windows, leveraging entire sentences or even paragraphs.

Language models may be implemented in various ways. For example, N-gram models predict the next word based on the previous N-1 words. Neural network-based language models include Recurrent Neural Networks (RNNs), Long Short-Term Memory (LSTM) networks, and more Transformer models. These models capture more complex language patterns and context dependencies. The transformer architecture, introduced with models like Bidirectional Encoder Representations from Transformers (BERT) and Generate Pre-trained Transformers (GPT), utilizes self-attention mechanisms to handle long-range dependencies potentially more effectively than RNNs or LSTMs.

Language models are often trained using large corpora of text. The training process involves adjusting the model's parameters to minimize the difference between its predicted word probabilities and the actual word sequences in the training data. This is typically done via techniques like maximum likelihood estimation and gradient descent.

Language models have a wide array of applications, including: text generation (e.g., producing coherent and contextually appropriate text); machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

Thus, a language model is a sophisticated tool in NLP that analyzes and generates human language by understanding the probabilistic relationships between words and leveraging large datasets to learn these relationships. They form the backbone of many modern NLP applications, enabling machines to interpret, generate, and interact with human language.

Described aspects utilize language model 116 for processing prompts for classifying received writing content. For example, prompt generator component 114 may generate a first prompt configured to cause language model 116 to generate and return an initial set of content groupings for classifying the received writing content. As used herein, an “initial set of content groupings” refers to preliminary classifications or categorizations of one or more received writing content excerpts based on similarities between each writing content excerpt. In some cases, the first prompt includes instructions for causing language model 116 to generate the initial set of content groupings based on similarities between a central idea conveyed by each of the writing content excerpts of the set of writing content excerpts. As used herein, a “central idea” refers to one or more of an identifiable specific meaning, theme, or intent conveyed by a received writing content excerpt based on linguistic features of the writing content excerpt.” As an example, a portion of the first prompt configured to cause language model 116 to generate an initial set of content groupings for writing content excerpts including work history statements for a given associated job title may state “First, analyze the similarity of the work history statements for the listed job title focusing on central ideas such as the specific meanings the pieces convey.” The first prompt further includes instructions configured to cause language model 116 to label each content grouping of the initial set of content groupings based on the central idea conveyed by each of the writing content excerpts corresponding to each content grouping. For example, the first prompt may cause language model 116 to label (e.g. name) a first grouping as relating to “Enhancing customer satisfaction” based on a first work experience excerpt stating “Enhanced customer satisfaction by providing attentive and friendly service” and a second work experience excerpt stating “Enhanced customer satisfaction by providing attentive service and anticipating guests needs”. The labels generated by language model 116 based on processing the first prompt may further include a group identifier and group name for each content grouping in the initial set of content groupings. A group identifier may include any alphanumeric label for identifying a given grouping. A group name includes any label or title for defining a scope or focus of a given grouping. For example, the labels for the writing content excerpts discussed above include a group identifier “Group 1”, and a group name “Customer Satisfaction” identifying the focus of the grouping.

In some cases, the first prompt is further configured to cause language model 116 to identify any labeled grouping of the initial set of content groupings that includes a number of writing content excerpts exceeding a threshold and then divide the identified labeled grouping into two or more sub-groupings. As used herein, a “sub-grouping” refers to a specific group created by dividing an initial content grouping of writing content excerpts into multiple segments once a threshold number of writing content excerpts for a singular grouping is exceeded. For example, a portion of the first prompt may instruct the language model to “divide any group with more than 4 writing content excerpts into 2 or more sub-groups having no more than 4 writing content excerpts each.” The first prompt thus limits the size of each content grouping, thereby preserving granularity of the groupings and reducing the amount of outliers and irrelevant content that may be inadvertently grouped by the language model due to overgeneralization and noise associated with larger grouping sizes that may obscure meaningful insights for correctly grouping content based on nuanced variations therein.

Prompt generator component 114 may further generate a second prompt configured to cause language model 116 to perform few-shot filtering to generate and return a first refined set of content groupings in which each writing excerpt is labeled with a binary feature indicating whether each respective writing content excerpt is relevant or irrelevant to a corresponding initial content grouping. As used herein, “few-shot filtering” refers to a process of refining sentence groupings based on a provided number of examples that function as guides or reference points for a language model performing the classifying of writing content excerpts into groupings based on similar meaning or ideas being conveyed. For example, the second prompt may include a configured number of examples, including classified writing content excerpts that have been grouped into a shared content grouping and any associated contextual information, such as an associated topic (e.g. a job title) for each example grouping. Language model 116 may then process the second prompt to further filter and validate the initial set of content groupings for received writing content by applying a “relevant” or “not relevant” label to each writing content excerpt for a respective initial content grouping into which they were originally classified (e.g. based on processing of the first prompt by the language model). As an example, the applied label may be a binary feature, such as a “1” for a writing content excerpt that is predicted to be relevant to its initially assigned grouping, or a “0” for a writing content excerpt predicted to be not relevant to its initially assigned grouping. The second prompt may be configured to instruct language model 116 to consider the contents of each writing excerpt, the assigned group name, and the associated contextual information (such as a topic) to determine an appropriate label to apply. In some examples, the second prompt is further configured to cause language model 116 to provide explainability statements detailing reasoning for labeling a given writing content excerpt as relevant or not relevant to a given grouping. Language model 116 thus generates a first refined set of content groupings including writing content excerpts labeled with binary features that may be leveraged by a classification model tasked with further refining the content groupings, as will be described in greater detail below.

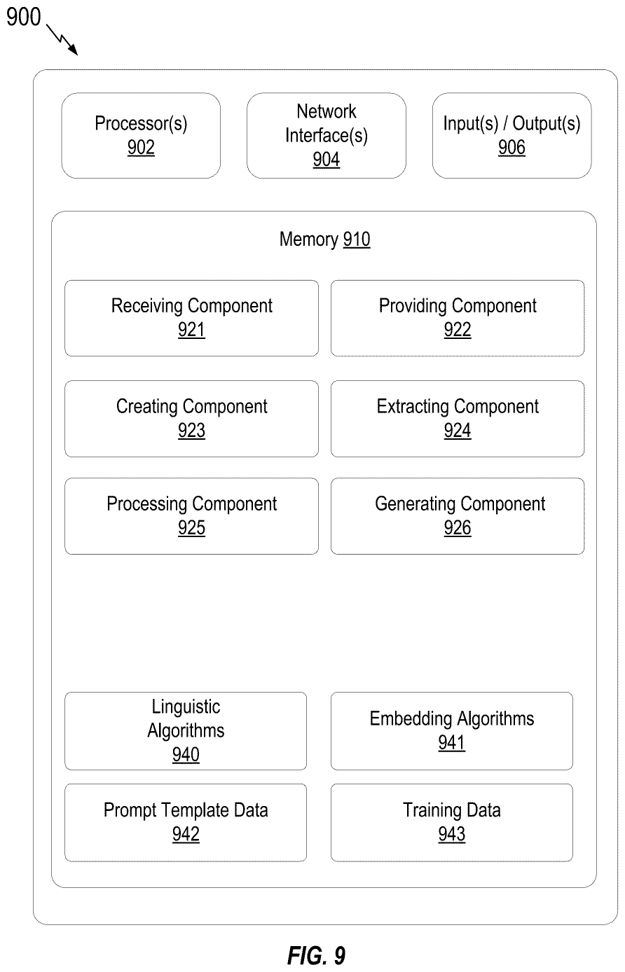

Writing content classification system 110 may be configured to use prompt generator component 114 to generate the first or second prompts using one or more prompt templates, such as stored within prompt template data 942 with reference to FIG. 9. The prompt template may include instructions corresponding to each of the first and second prompt and a set of placeholders for inputting variables for specific input data during runtime. For example, the first prompt template for generating the first prompt may include placeholders for the input writing content excerpts and their respective associated topics.

In certain aspects, language model 116 is hosted locally within writing content classification system 110. In other aspects, language model 116 is hosted remotely and invoked using an application programming interface (API), such as via API calls performed by an API gateway 118 of writing content classification system 110.

In addition to employing language model-driven classification techniques for grouping received writing content, writing content classification system 110 further employs techniques for performing classification based on extracted linguistic features for created pairs of received writing content excerpts. To create writing content excerpt pairs, the initial content groupings returned by language model 116 are passed to an excerpt pair creator component 120 configured to create writing content excerpt pairs for each unique pairing combination of a given initial content grouping. If an initial content grouping “Group 1” includes writing content excerpts “E1”, “E2” and “E3”, then excerpt pair creator component would generate a first pair including excerpts “E1” and “E2”, a second pair including excerpts “E1” and “E3”, and a third pair including excerpts “E2” and “E3”.

The created writing content excerpt pairs are then provided to a linguistic feature extractor component 122. The provided writing content excerpt pairs allow for capturing of relationships and similarities (e.g. based on extracted linguistic features) between the writing content excerpts of the pair that may be leveraged downstream by the classification model when further refining content groupings. Linguistic feature extractor component 122 utilize one or more algorithms or models for extracting the set of linguistic features for each writing content excerpt, such as using one or more algorithms stored within linguistic algorithms 940 with reference to FIG. 9. For example, linguistic feature extractor component 122 may utilize one or more linguistic algorithms configured to enable the linguistic feature extractor component 122 to perform techniques that include, but are not limited to, Jaccard Similarity measurements, Euclidean distance measurements, Levenshtein distance (edit distance) measurements, length disparity measurements, Word Mover's Distance (WMD) measurements, Sorensen-Dice similarity measurements, and the like. Examples of linguistic features that may be extracted by linguistic feature extractor component 122 are described in greater detail below.

In aspects, the extracted set of linguistic features includes a semantic similarity measurement between each pair of writing content excerpts. For example, a writing content excerpt pair may include first writing content excerpt stating “Managed a group of programmers” and a second writing content excerpt stating “Led a group of software developers”. Linguistic feature extractor component 122 may utilize a first algorithm or model, such as Word2VEC, BERT, or any other suitable models or algorithms (e.g. stored within embedding algorithms 941 with reference to FIG. 9), to obtain word embeddings representing each writing content excerpt of a given pair. Linguistic feature extractor component 122 then determines a quantifiable measurement for how similar the meanings or concepts are between the respective writing content excerpts, such as by using cosine similarity, Euclidean distance, or other techniques for comparing the obtained embeddings. In certain aspects, linguistic feature extractor component 122 may determine a semantic similarity measurement for a configured number of sequential words in each sentence. For example, the extracted set of linguistic features may include a semantic similarity measurement for the first five words in each sentence of a given pair. Extracted semantic similarity measurements may be represented by a normalized score between 0 and 1, where 1 corresponds to identical writing content excerpts in a pair.

In some cases, the extracted set of linguistic features further includes a length disparity measurement between each writing content excerpt of a given pair. As length disparity between a pair of writing content excerpts increases, the likelihood of them being properly grouped based on conveyed meaning decreases. For example, a pair of sentences with an increased length disparity likely convey meanings using different levels of detail or granularity, thereby causing sentence with the greater length to include additional meaning or content that is dissimilar to the sentence with the shorter length. Linguistic feature extractor component 122 may extract a measured difference in the number of words or characters within each of the writing content excerpts of a given pair. In some cases, a lengthy disparity measurement may be reflected as a score including any whole number integer corresponding to the difference in the total number of words between two writing content excerpts being compared.

In other examples, the extracted set of linguistic features further includes a Jaccard similarity measurement between respective writing content excerpts of each writing content excerpt pair. As used herein, “Jaccard similarity measurements” refer to a ratio including a number of shared words contained in each writing content excerpt of a given pair over the number of distinct words contained in each sentence of the given pair. The Jaccard similarity measurement may be converted into a normalized score between 0 and 1 where a score of 1 indicates the pair of sentences share all words contained in each writing content excerpt.

The above-described linguistic features (semantic similarity measurement, length disparity measurements, Jaccard similarity measurement) are merely illustrative. Described writing content classification systems may be configured to extract additional or fewer linguistic features for each created writing content excerpt pair as may be useful for further refining or validating predicted content groupings using the employed hybrid framework.

Writing content classification system 110 further includes a classification model 124. As discussed above, classification model 124 may include various types of linear models (e.g. support vector machines), neural networks, probabilistic models, instance-based learning models (e.g. k-Nearest Neighbors based models), stacked generalization models, graph-based models, or any other type of machine learning models or techniques useful for classifying writing content into groupings.

In some aspects, classification model 124 may include any decision tree-based classification model that employs supervised machine learning algorithms or techniques configured to recursively split data based on feature values to create tree-like structures of decision nodes and leaf nodes. Each path through the tree represents a set of rules leading to a prediction. Decision tree-based classification models may be used for a variety of classification and regression tasks. In some aspects, classification model 124 may include a basic decision tree model configured to use a single tree for classification, such as classification and regression trees (CART). In other aspects, classification model 124 may include an ensemble tree based model that combines multiple decision trees to improve classification accuracy and reduce overfitting, such as using bagging-based methods (e.g. random forest models) or boosting-based methods (e.g. for adaptive boosting or gradient boosting trees (GBT). In some aspects, classification model 124 may include an oblique decision tree-based model for using linear combinations of features (rather than single features) at decision nodes to allow more flexible splitting, such as linear oblique trees (LOTs), householder-CART trees and the like. In other examples, classification model 124 may include any hybrid or specialized decision tree-based model, such as extremely randomized trees (ERT), rotation forests, Bayesian decision trees, model trees using linear classifiers or regressors, or soft decision trees. Classification model 124 may further implement any other decision tree-based classification model usable to perform illustrative methods described herein.

In some examples, classification model 124 is used to classify writing content excerpts into groupings. In the context of classifying writing content excerpts, decision tree-based models advantageously provide interpretable, rule-based decisions that can capture meaningful patterns in linguistic features (e.g. syntax, word usage, structure, and the like) while also handling provided numerical and categorical data (e.g. sentence lengths, number of characters, parts-of-speech-tags) for accurately classifying and grouping similar writing content.

In some examples, classification model 124 includes a random forest classification model. Random forest classification models are designed to combine multiple decision trees to create a “forest” in which each decision tree is trained on a random subset of data and features in a bootstrap aggregation (bagging) process. The random forest classification model then aggregates the outputs of individual decision trees by majority voting for performing classification. Each node in a given decision tree represents a feature-based decision (e.g. related to a given language model-based label, extracted linguistic feature, or other considered feature), and each branch represents an outcome of a given decision. The decision tree recursively splits data based on selected features until a final classification leaf node is reached. Because each tree is trained differently, the combined result is more accurate, robust to noise, and less prone to overfitting as compared to use of a single decision tree.

Random forest classification models are particularly useful for classifying and grouping writing content excerpts based on learned patterns from various linguistic features. By training on labeled examples, the random forest classification model learns decision boundaries to distinguish writing content excerpt groupings based on statistical patterns. Since each decision tree considers different feature subsets, random forest classification models further capture diverse aspects of sentence similarity, even if the writing content excerpts differ in wording.

Classification model 124 is trained to leverage data obtained from both language model-driven techniques, such as the labeled writing content excerpts obtained from the combination of the initial content grouping and few-shot filtering performed by language model 116, and the extracted sets of linguistic features from linguistic feature extractor component 122 to generate a second refined set of content groupings for received writing content excerpts. As discussed above, employing a hybrid classification framework mitigates weaknesses or shortcomings of individually employing either of the model types in isolation to classify writing content. For example, classification model 124 may mitigate the tendency of language model 116 to include false positives (e.g. inaccurately grouped writing content excerpts having different conveyed meanings or central ideas) due to difficulties excluding writing content excerpts containing unique content from an existing grouping. The classification model 124 further mitigates the reduced accuracy experienced from relying solely on linguistic features and semantic data that insufficiently account for context and nuance of individual writing content excerpts. Accordingly, classification model 124 functions as a part of a hybrid framework which reduces single-point failures of any individual classification technique, thereby providing the technical benefit of reducing error propagation and increasing accuracy when classifying writing content.

In particular, classification model 124 returns the second refined set of content groupings for received writing content excerpts that are based on considering both the extracted sets of linguistic features and the generated first refined set of content groupings labeled with the binary features for the initial content groupings provided using the language model-driven techniques. In some examples, classification model 124 may label all writing content excerpts that are predicted to match with other sentences of an existing group name (e.g. of an initial content grouping) with a corresponding label including the existing group name and group identifier. For writing content excerpts that are predicted to fall outside of the existing groupings, classification model 124 instead assigns a label indicating that the content is individualized, assigning it a unique grouping.

Classification model 124 may then provide the second refined set of content groupings with the classifications for the received writing content back to an output receiving component 126. Output receiving component 126 may return the second refined set of content groupings and any associated labels or data to user 102 via device 104. In some cases, output receiving component 126 may instead store the second refined set of content groupings within storage 128, which may include any local or cloud-based storage for storing the classifications for the received writing content excerpts. In other examples, output receiving component 126 may instead be configured to provide the second refined set of content groupings back to web-based application 106, such that it may be used to improve content delivery for users of web-based application 106. For example, the second refined set of content groupings can be used to ensure only a most-relevant and unique writing content excerpt is delivered as content to a user. The writing content classification system further enables rapid addition and classification of new writing content excerpts while ensuring redundant content is accounted for based on accurately grouping similar content together. This may be useful for preventing delivery of redundant content to a user, for example, based on delivering only a single writing content excerpt of a given grouping to a user. The second refined set of content groupings further ensure that irrelevant content is filtered out by assigning unique writing content excerpts an individualized grouping, thereby mitigating the risk of inadvertently delivering irrelevant content to a user based on a writing content excerpt being included within an irrelevant grouping.

Example Process of Training a Random Forest Classification Model for Use in a Hybrid Classification Framework

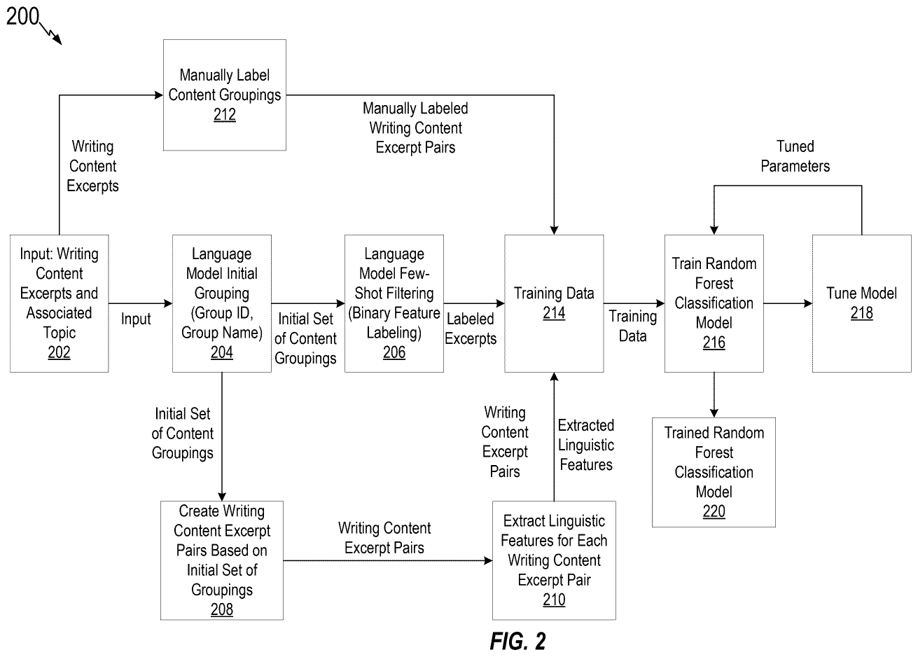

FIG. 2 depicts an example process 200 of training a random forest classification model implementable by a writing content classification system for classifying writing content using a hybrid classification framework. In particular, training data (e.g. obtained at block 214) usable for training a random forest classification model (e.g. at block 216) is obtained by sourcing data from one or more of three different processes, including language model-driven techniques, linguistic feature extraction techniques, and manual labeling of writing content. Portions of the training data at block 214 are generated using processes performable by described writing content classification systems, for example, using writing content classification system 110 described above with reference to FIG. 1. While process 200 relates to an example for training a random forest classification model to be implemented by the writing content classification system, other examples in accordance with the present disclosure may include alternative decision tree-based models implementable by the writing content classification system that are trained using similar training data (e.g. training data described at block 214).

At block 202, process 200 begins with receiving input including writing content excerpts and associated topics, for example, using an input receiving component, such as input receiver component 112 described above with reference to FIG. 1 and/or a receiving component 921 described below with reference to FIG. 9. For example, the received input may include one or more writing content excerpts and associated topics.

At block 204, the received input is provided to a language model to generate and return initial content groupings for the received writing content excerpts. For example, the received input may be provided to the language model using a providing component, such as providing component 922 with reference to FIG. 9. The returned initial content groupings further include a group identifier (ID) and a group name. Block 204 may be performed, for example, using a language model of the writing content classification system, such as language model 116 of writing content classification system 110 with reference to FIG. 1. The initial content groupings may correspond to an initial set of content groupings returned by a language model processing a first prompt generated by a prompt generator. For example, the first prompt may be generated using similar means as described above with regard to generating a first prompt using prompt generator component 114 with reference to FIG. 1.

At block 206, the initial set of content groupings are provided to the language model of the writing content classification system within a second prompt configured to cause the language model to perform few-shot filtering to generate a first refined set of content groupings including labeled writing content excerpts. The labeled writing content excerpts are labeled with a binary feature, such as a “relevant” label or an “irrelevant label” that indicate whether each labeled writing content excerpt was predicted to belong to an initially assigned grouping. The writing content classification system provides the language model with the second prompt using a providing component, such as providing component 922 with reference to FIG. 9. The labeled writing content excerpts of the first refined set of content groupings are labeled with a binary feature indicating whether each writing content excerpt is relevant or irrelevant to an initial content grouping. The second prompt configured to cause the language model to perform few-shot filtering may be generated by a prompt generator, for example, using similar means as described above regarding generating a second prompt using prompt generator component 114 with reference to FIG. 1.

At block 208, the writing content classification system creates writing content excerpt pairs based on the initial set of content groupings, for example, using an excerpt pair creator component, such as excerpt pair creator component 120 described above with reference to FIG. 1 and/or creating component 923 with reference to FIG. 9. The writing content excerpt pairs may be created using similar means as described above regarding generating writing content excerpt pairs using excerpt pair creator component 120 with reference to FIG. 1.

At block 210, the writing content classification system extracts linguistic features for each created writing content excerpt pair, for example, using a linguistic feature extractor component, such as linguistic feature extractor component 122 described above with reference to FIG. 1 and/or using an extracting component 924 with reference to FIG. 9. The extracted set of linguistic features may be extracted from the writing content excerpts of each pair using similar means as described above regarding extracting sets of linguistic features using linguistic feature extractor component 122 with reference to FIG. 1.

At block 212, the writing content excerpts corresponding to the received input from block 202 are manually labeled by content experts. In certain aspects, the writing content classification system may be implemented as an application configured to allow an administrator to access writing content excerpts for manual labeling. In other aspects, an administrator of the writing content classification system may separately provide the received writing content excerpts to be processed by the writing content classification system to one or more writing content experts for labeling. In some cases, the manually labeled writing content excerpts may correspond to writing content excerpt pairs that are labeled as relevant or irrelevant by the content expert based on whether the content expert determines that the writing content excerpts of a given pair are similar enough to be grouped together.

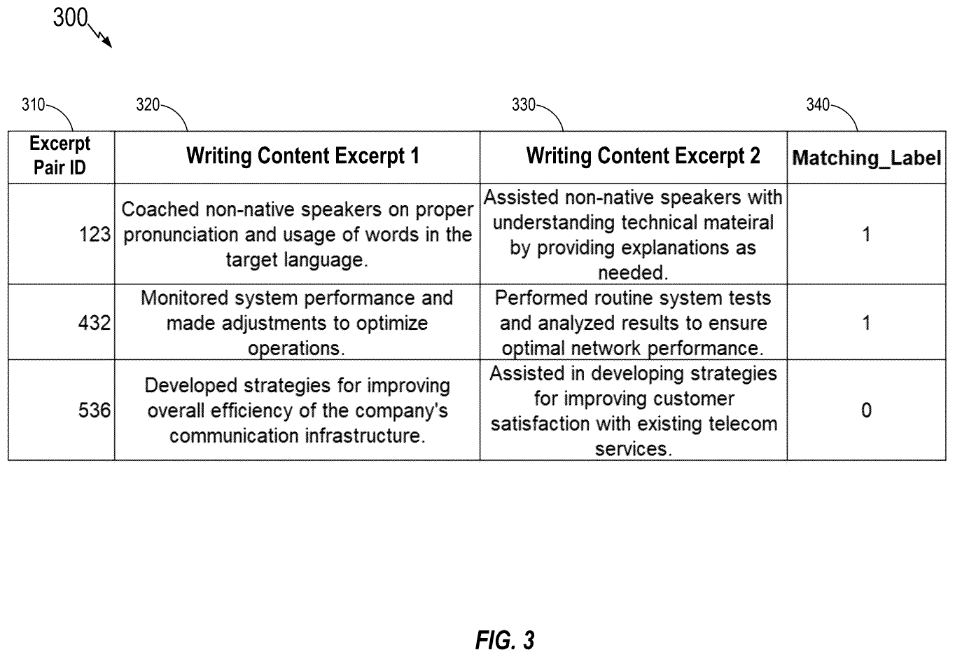

FIG. 3 depicts a table 300 including example pairs of writing content excerpts that have been manually labeled for incorporating into a training dataset usable to train a decision tree based model implementable by a writing content classification system according to one or more aspects. The manually labeled writing content pairs may serve as ground truth data for training the decision tree-based model. Each row of table 300 corresponds to a given writing content excerpt pair that has been manually labeled by a content expert. A first column 310 includes a writing content excerpt pair identifier (ID) that may be used to identify each unique writing content excerpt pair. A second column 320 includes a first writing content excerpt of a given pair. A third column 330 includes a second writing content excerpt that is paired with a corresponding first writing content excerpt from second column 320 within a shared row of table 300. A fourth column 340 includes a manual label provided by the content expert. In table 300, a manual label represented by “1” is assigned by the content expert based on determining that the writing content excerpts of a given pair (e.g. sharing a row of table 300) are similar enough that they should be grouped together (e.g. a relevant label). Alternatively, a manual label represented by “0” is assigned if the content expert determines that the writing content excerpts of a given pair are dissimilar (e.g. an irrelevant label), and should therefore not be grouped together. Thus, a content expert may “group” content by applying a label indicating that one or more writing content excerpts are similar enough to be grouped together.

The content expert may be provided with a set of instructions to guide their determination of which label to apply to each writing content excerpt pair. For example, the instructions may state the following:
1. Label writing content excerpt pairs with a “1” if they describe similar responsibilities, tasks, projects, or achievements for the associated topic.
2. Label writing content excerpt pairs with a “0” if they describe distinct responsibilities, tasks, projects, or achievements for the associated topic.

The provided set of instructions may further include additional statements for clarifying how certain features or considerations should be handled by the content experts. This increases consistency in labeling between content experts and provides increased control in guiding any preferred bias of the decision tree-based model when it is trained using the content expert labels. As an example, the instructions may indicate that the content expert should be biased towards grouping vague sentences that seem related. In some cases, the instructions may further indicate that writing content excerpt pairs should be grouped if a first writing content excerpt includes a broad description of a task and a second writing content excerpt includes a narrow description of a task. The provided set of instructions thus reduces labeling inconsistencies between content experts, thereby providing for a more consistent dataset usable to train a model having improved performance due to fewer mislabeled training examples.

Returning to process 200 of FIG. 2, at block 214, training data is generated for example, using a generating component, such as generating component 926 with reference to FIG. 9. The training data is generated by combining the labeled writing content excerpts corresponding to the few-shot filtering performed by the language model at block 206, the set of linguistic features for the writing content excerpt pairs extracted at block 210, and the manually labeled writing content excerpt pairs obtained from the content experts as described at block 212.

At block 216, the training data is used to train a random forest classification model. For example, the random forest classification model may be trained using training data of the writing content classification system, for example, stored within training data 943 with reference to FIG. 9. The training algorithms for training the random forest classification model may use bootstrap aggregating (sometimes referred to as “feature bagging”) to train each decision tree of the random forest classification model by sampling a random subset of features from the training dataset from block 214. For example, at each node of a decision tree, a random subset of features is selected to create diversity between individual trees. Each node may further include a threshold value for a given feature being considered that may be used to determine whether writing content excerpts of a pair should be more or less likely to be grouped together. As an example, a first node of a given tree may be associated with whether a pair of writing content excerpts pair has been manually labeled as similar enough to be grouped (e.g. labeled with a “1” by a content expert evaluating similarity), while a second node may be associated with a determination of whether a pair of writing content excerpts have a Jaccard similarity measurement above a threshold (e.g. 0.7) to measure how similar the meanings for the individual writing content excerpts are based on their respective corresponding embeddings. In other examples, a node of a given tree may be associated with a determination of whether a pair of writing content excerpt pairs have a semantic similarity score for comparing a first 5 words of each sentence that is above a threshold of 0.9. This enables the decision tree to consider early sentence phrasing similarity to capture topic alignment when considering groupings for writing content excerpt pairs. In aspects, an example node of a given tree may be associated with a determination of whether a length difference between two writing content excerpts of a given writing content excerpt pair satisfies a threshold. Additional nodes may be associated with additional features and corresponding thresholds for predicting whether to group a pair of writing content excerpts.

During training, additional nodes may be added to each decision tree until a stopping criteria is met, such as a maximum depth or a minimum number of samples per node is met. The thresholds for various considered features may further be learned during training to improve the accuracy of the decision tree in accurately grouping writing content excerpts. The training process results in a “forest” of individual decision trees trained using different random feature subsets and samples, such that the random forest classification model may generate a classification for a received pair of writing content excerpts based on majority voting by all of the decision trees in the random forest.

At block 218, the random forest classification model is tuned based on model evaluation. For example, a validation dataset may be used to evaluate the performance of the random forest classification model with respect to its ability to accurately classify writing content excerpts of the validation dataset. The performance may be evaluated using metrics such as accuracy, precision, recall, F1-scores, or the like.

In some cases, to improve performance of the random forest classification model, certain hyperparameters may be adjusted (i.e. tuned) as desired. Example hyperparameters may include, but are not limited to, a number of trees in the random forest, a maximum depth of the trees, a maximum features per split of a given node, a minimum samples used per node, or other modifiable parameters related to the random forest and the individual decision trees therein.

At block 220, a trained random forest classification model is obtained. The random forest classification model may thus be utilized by the writing content classification system to classify newly received writing content excerpt pairs by generating further refined content groupings having increased accuracy based on the employed hybrid framework used to train the random forest classification model. In some examples, the random forest classification model is configured to determine a similarity prediction for writing content excerpt pairs derived from input including writing content excerpts and associated topics. For example, the similarity prediction may include a confidence score for indicating the likelihood that a writing content excerpt of a given pair is relevant to an assigned grouping for the other writing content excerpt of the pair. The confidence score may be used to determine whether a writing content excerpt is predicted to be relevant (e.g. properly grouped) into an existing shared grouping associated with the other writing content excerpt of the pair or irrelevant (e.g. improperly grouped) with the existing grouping, for example, based on comparing the confidence score to a threshold. If a given writing content excerpt is predicted to be irrelevant with respect to all other writing content excerpts (e.g. considered as individual pairs) in an existing grouping being considered, then the random forest classification model will label the irrelevant writing content excerpt as belonging to an individualized grouping. The similarity predictions from the random forest classification model are thus usable to generate a second refined set of content groupings for further increasing the precision of grouping the writing content excerpts, as described in greater detail below.

### Example Process of Classifying Writing Content Into Groupings Using a Hybrid Classification Framework

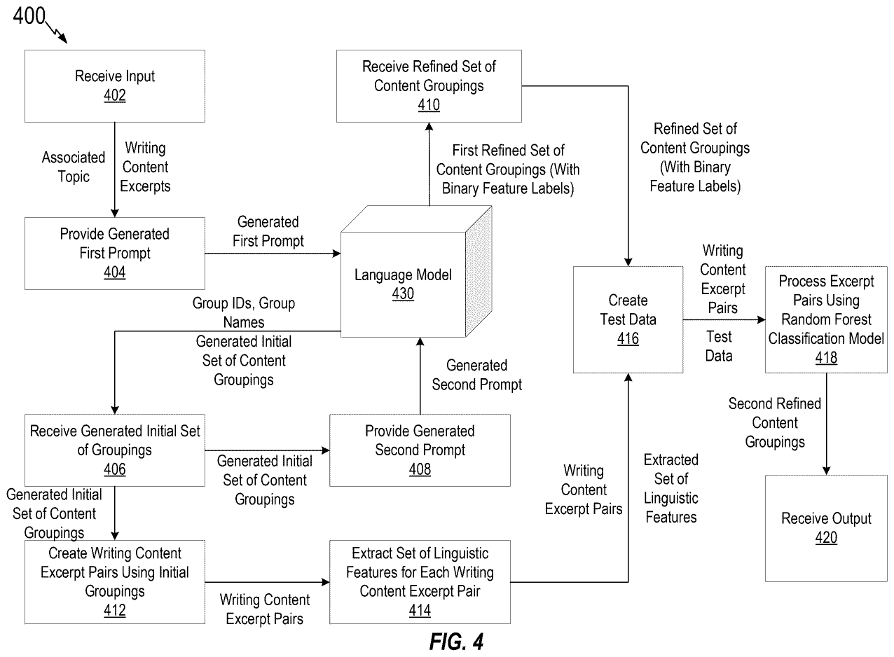

FIG. 4 depicts an example process 400 implementable by a writing content classification system for classifying writing content using a hybrid classification framework according to one or more aspects. The writing content classification system performing process 400 may implement any classification model (e.g. decision tree-based models or other types of machine learning models), for example, including any classification model 124 as described above with reference to FIG. 1. The classification model implemented by the writing content classification system may be trained using training data obtained in accordance with process 200 described above with reference to FIG. 2. In the depicted example, process 400 is shown to be performed using a random forest classification model trained using training data obtain in accordance with the training data obtained at block 214 as described above with reference to process 200 of FIG. 2. Process 400 enables any employed decision tree-based model (in this case a random forest classification model) to leverage a combination feature data derived from language model-driven prompting techniques and extraction of linguistic features for pairs of receiving writing content excerpts. The decision tree-based model thus mitigates weaknesses or shortcomings of individually employing any of the aforementioned techniques to classify writing content excerpts into groupings. This provides the technical benefit of improving scalability by reducing storage and computational needs associated with handling and processing of duplicate, redundant, or inaccurately classified content.

At block 402, the writing content classification system receives input including writing content excerpts and associated topics, for example, using an input receiving component, such as input receiver component 112 described above with reference to FIG. 1 and/or a receiving component 921 described below with reference to FIG. 9.

At block 404, the writing content classification system provides a generated first prompt to language model 430, for example, using a prompt generator component, such as prompt generator component 114 described above with reference to FIG. 1 and/or generating component 926 described below with reference to FIG. 9. The first prompt is configured to cause a language model, such as language model 430 to process the first prompt to return a generated initial set of content groupings for the received writing content excerpts, as discussed above with reference to FIG. 1. An example first prompt provided to the language model may state the following:
Act as a resume writer and content expert with a deep understanding of contextual meaning. You will be provided with writing content excerpts for the resume of a [Job Title]. Group the statements that are highly similar in meaning based on central ideas and meaning conveyed. Create between 10 and 50 groups with writing content excerpts convey with no more than 4 writing content excerpts per group.

At block 406, the writing content classification system receives, from language model 430, the initial set of content groupings, for example, received at the prompt generator component 114 described above with reference to FIG. 1 and/or receiving component 921 described below with reference to FIG. 9. For example, the initial content groupings received by the writing content classification system are generated by the language model based on the language model processing the first prompt provided at block 404. As previously discussed, the received initial set of content groupings further includes group IDs and group names for each of the grouped writing content excerpts.

At block 408, the writing content classification system provides a second prompt to language model 430. The second prompt may be generated, for example, using a prompt generator component, such as prompt generator component 114 described above with reference to FIG. 1 and/or generating component 926 described below with reference to FIG. 9. The second prompt is provided to language model 430 to cause language model 430 to perform few-shot filtering to return a first refined set of content groupings in which each writing excerpt is labeled with a binary feature indicating whether each respective writing content excerpt is relevant or irrelevant to a corresponding initial content grouping, as described above with reference to FIG. 1. An example second prompt provided to the language model may state the following:
You are tasked with determining whether writing content excerpts associated with job descriptions for specific titles should be grouped as similar or not. You must consider the content of each writing content excerpt, the group name for its assigned grouping, and the title of the job associated with each writing content excerpt. Apply a binary feature label of “1” or “0” to the given writing content excerpt indicating whether the writing content excerpt is relevant to the grouping (“1”) or irrelevant to the grouping “0”. Consider the following examples as guidance:
Example 1 of highly similar writing content excerpts that should be grouped together:
Group Name: Customer Satisfaction
Job Title: Restaurant Wait Staffer
   Excerpt 1: Enhanced customer satisfaction by providing attentive and friendly service during their dining experience
   Excerpt 2: Enhanced customer satisfaction by providing attentive service and anticipating guests needs
   Reason: Both writing content excerpts are centered on customer satisfaction and how it is provided
Example 2 of writing content excerpts that are not similar enough to be grouped together:
Job Title: Restaurant Wait Staffer
   Excerpt 1: Quickly reset and cleaned up tables after customers left to enable speedy turnaround and guest flow.
   Excerpt 2: Inspected dishes and utensils for cleanliness
   Reason: While both writing content excerpts are related to cleaning or cleanliness, they are focused on different aspects.

Writing content excerpt 1 is focused on tables and guest flow, while writing content excerpt 2 is focused on individual dishes and utensils.

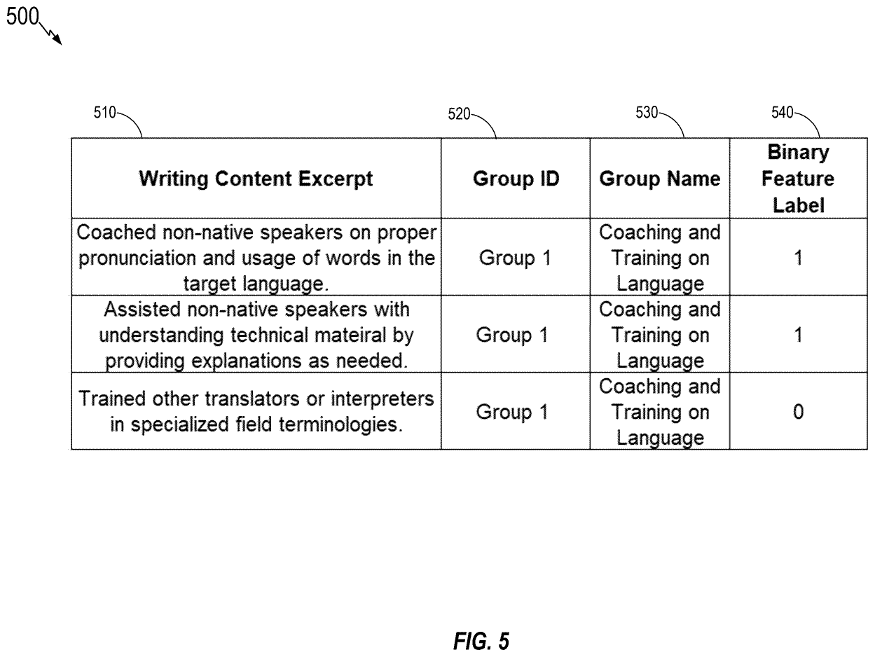

FIG. 5 depicts a table 500 including example labeled writing content excerpts obtainable by few-shot filtering techniques implementable by a language model of a writing content classification system according to one or more aspects.

A first column 510 includes writing content excerpts. The writing content excerpts in column 510 have already been initially grouped by a language model. For example, the writing content excerpts in column 510 may have been initially grouped by a language model of the writing classification processing a first generated prompt provided in accordance with block 404 of process 400 described above with reference to FIG. 4. In particular, the writing content excerpts in column 510 were initially grouped into an initial group having a group ID represented by “Group 1” as shown in a second column 520. A third column 530 indicates that “Coaching and Training of on Language” is the group name corresponding to the initial content grouping returned by the language model.

A fourth column 540 includes a binary feature label applied by the language model of the classification system as a result of performing few-shot filtering, such as based on processing a second generated prompt provided in accordance with block 408 of process 400 described above with reference to FIG. 4. As shown, the writing content excerpts in the first and second rows of column 510 were labeled with a binary feature label represented by “1”, indicating that each of the writing content excerpts was predicted to be similar enough to validate or confirm the initial content grouping of the sentences into “Group 1.” The sentence in the third row of column 510 is instead assigned a binary feature label represented by a “0,” indicating that the writing content excerpt was predicted to be dissimilar or not relevant with respect to “Group 1”.

Returning to process 400 of FIG. 4, at block 410, the writing content classification system receives, from language model 430, the first refined set of content groupings. For example, the first refined set of content groupings may be received at the prompt generator component 114 described above with reference to FIG. 1 and/or receiving component 921 described below with reference to FIG. 9. The first refined set of content groupings including the binary feature labels (such as described above at FIG. 5) serve as one of three components used to create test data at block 416.

At block 412, the writing content classification system creates writing content excerpt pairs based on the initial set of content groupings, for example, using an excerpt pair creator component, such as excerpt pair creator component 120 described above with reference to FIG. 1 and/or creating component 923 described below with reference to FIG. 9. The writing content excerpt pairs may be created using similar means as described above regarding generating writing content excerpt pairs using excerpt pair creator component 120 with reference to FIG. 1. The writing content excerpt pairs from block 412 are then provided as a second component for creating test data at block 416.

At block 414, the writing content classification system extracts a set of linguistic features for each writing content excerpt pair, for example, using a linguistic feature extract component, such as linguistic feature extractor component 122 described above with reference to FIG. 1, and/or extracting component 924 described below with reference to FIG. 9. The extracted set of linguistic features may be extracted from the writing content excerpts of each pair using similar means as described above regarding extracting sets of linguistic features using linguistic feature extractor component 122 with reference to FIG. 1. The extracted set of linguistic features are provided as a third component for creating test data at block 416.

At block 416, writing content classification system combines each of the binary feature labels received at block 410, the created writing content excerpt pairs at block 412, and the extracted set of linguistic features at 414 to create test data.

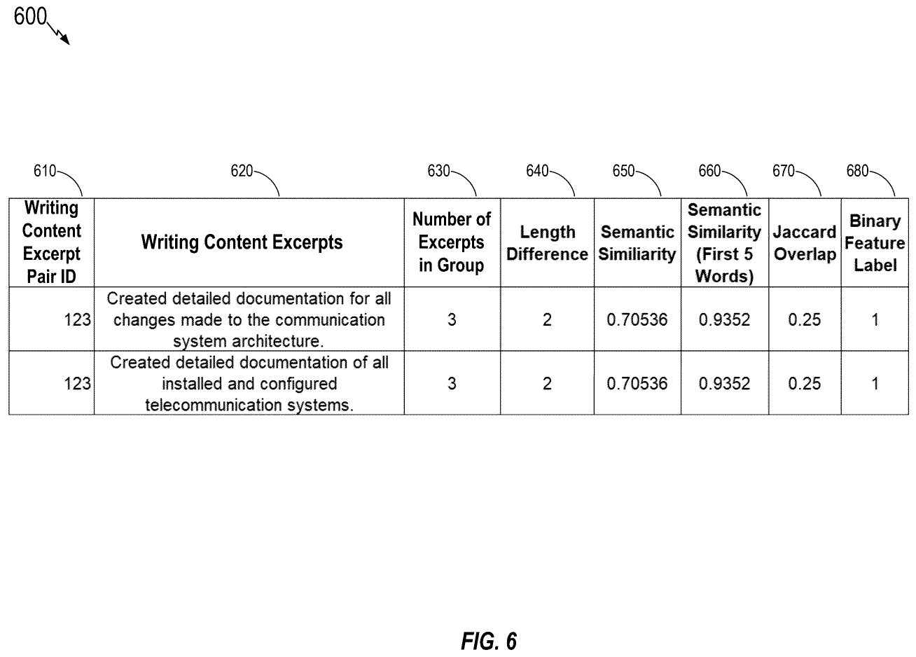

FIG. 6 depicts a table 600 including example test data that may be processed using a decision tree-based model (e.g. a random forest classification model) implemented by a a writing content classification system according to one or more aspects.

Table 600 includes a first column 610 including writing content excerpt pair identifiers (ID) associated with a pair of sentences. Column 620 includes a first writing content excerpt and a second writing content excerpt sharing the sentence pair ID “123.” For example, the pair of writing content excerpts in column 620 could correspond to a writing content excerpt pair created at block 412 of process 400 as described above with reference to FIG. 4. Column 630 shows a number of writing content excerpts contained in an initial content grouping containing the pair of writing content excerpts. For example, the number of writing content excerpts in column 630 could correspond to a number of writing content excerpts within an initial content grouping that share a common group ID. In this case, the initial content grouping containing the pair of writing content excerpts from column 620 includes a total of three writing content excerpts.

The test data within table 600 further includes a set of extracted linguistic features. For example, columns 640-670 each include extracted linguistic features based on comparing the text of each of the individual sentences from column 620. For example, the features in columns 640-670 may be obtained by performing a process similar to block 210 of process 200 as described above with reference to FIG. 2, and block 414 of process 400 as described above with reference to FIG. 4.

In particular, column 640 compares the length difference between each sentence of the pair, where the value of “2” indicates that the first sentence includes 2 additional words when compared to the second sentence.

Column 650 includes a semantic similarity score, such as based on comparing embedding representations of each sentence of the pair. As shown, the semantic similarity score may be converted to a normalized score between 0 and 1, where 1 indicates that the sentences are identical and 0 indicates no similarities between the sentences being compared. Column 660 includes a semantic similarity score based on comparing the first 5 words of each sentence from the pair of sentences. In this instance, the only difference between the first 5 words of each sentence of the pair is found in the fourth word which includes “for” in the first sentence and “of” in the second sentence. Accordingly, the semantic similarity score for the first 5 words is 0.9352, where a score of 1 indicates that two sentences are identical.

Column 670 includes a Jaccard overlap score. In some examples, the Jaccard overlap score is calculated after removing stop words from the two sentences. As used herein, a “stop word” refers to common words that are removed prior to performing certain language processing techniques (such as calculating a Jaccard overlap score) based on a lack of meaning or context associated with the words. Examples of stop words may include, but are not limited to “the”, “a”, and “is”. In other examples, the Jaccard overlap score is calculated based on considering only nouns and verbs in each sentence of the pair. The Jaccard overlap scores may be calculated based on a ratio including the number of shared words contained in each sentence of a given pair over the number of distinct words contained in each sentence of the given pair.

Column 680 includes a binary feature label applied by a language model of the writing classification system based on performing few-shot filtering to further refine the initial content grouping for each sentence of the pair of sentences being considered. The binary feature label in column 680 may be generated, for example, in accordance with block 206 of process 200 described above with reference to FIG. 2 or blocks 408-410 of process 400 described above with reference to FIG. 4. In column 680, each of the sentences of the depicted pair of sentences has a binary feature label of “1” applied thereto, indicating that each sentence was predicted by the language model to be relevant to the generated initial content grouping.

Returning to FIG. 4, at block 418, the writing content classification system then processes the writing content excerpt pairs and corresponding test data, for example, using a random forest classification model. In other aspects, the writing content classification system may implement other decision tree-based models or any other types of machine learning models such as in accordance with classification model 124 described above with reference to FIG. 1. When performing process 400, the random forest classification model may process each received writing content excerpt pair to generate a second further refined set of content groupings for further validating and improving the classification of the received writing content excerpts based on processing each pair. The second further refined set of content groupings may include a relevant or a not relevant label for each writing content excerpt that is based on processing both the extracted set of linguistic features and the binary feature labels (e.g. as shown in FIG. 6) for each pair of writing content excerpts. The random forest classification model may navigate each decision tree-based on binary decisions corresponding to one or more configured thresholds associated with available extracted linguistic features. As an example, the random forest classification model may navigate a given node of a decision tree by determining whether a calculated Jaccard similarity score for the first 5 words of a given writing content excerpt pair exceeds a threshold of 0.8, thereby indicating that the Jaccard similarity score indicates the sentences are likely similar enough to be grouped together. The random forest classification model is trained to include decision trees configured to consider each of the extracted linguistic features and one or more associated thresholds for each of the writing content excerpts of a given pair, where each node in a given decision tree represents a feature-based decision, and each branch represents an outcome of a given decision. The decision trees of the random forest classification model are further configured to weigh and consider the binary feature label obtained using prompting techniques described above. The random forest classification model will then calculate an aggregated score by aggregating the outputs of individual decision trees by majority voting. The aggregated score is then used to determine whether to apply a “relevant label” or a “not relevant” label to each writing content excerpt based on whether the aggregated score is above or below a threshold, thereby generating the second refined set of content groupings.

The random forest classification model may further label each respective writing content excerpt with a corresponding group identifier and a corresponding group name derived from the initial content groupings received from the language model based on processing of the first generated prompt, for example, as described above at block 204 of process 200 with reference to FIG. 2 and blocks 404 and 406 of process 400 with reference to FIG. 4.

In some cases, the random forest classification model may apply a not relevant label to a writing content excerpt for which the calculated aggregated scores of each pairwise comparison involving the writing content excerpt are each below the aggregated score threshold. The random forest classification model will identify the writing content excerpt as an individualized writing content excerpt that is irrelevant to any existing grouping of the initial set of content groupings. The random forest classification model will then apply an individualized grouping label to the individualizing writing content excerpt.

At block 420, the writing content classification receives output including the second refined content groupings, for example, using an output receiving component such as output receiving component 126 described above with reference to FIG. 1 and/or receiving component 921 described below with reference to FIG. 9. The received output may include the calculated aggregated scores for each writing content excerpt pair and the refined set of content groupings included a “relevant” or “irrelevant” label for each writing content excerpt with a corresponding group identifier and group name. For example, the output may be compiled within a report, a table, or any other output for conveying the information generated by the random forest classification model processing the provided writing content excerpt pairs and corresponding data.

Accordingly, process 400 illustrates how a writing content classification system, such as described with respect to FIG. 1, employs a random forest classification model that processes both labeled writing content excerpts (e.g. based on the binary feature labels) generated via language model-driven prompting techniques and a set of linguistic features extracted for each writing excerpt pair to classify received writing content excerpts. Process 400 enables classification of received writing content excerpts with increased precision based on considering contextual information through the use of language model-driven prompting, while reducing LM-based false positives through the use of random forest classification that is further informed by extracted linguistic features that provide additional semantic-based context. This reduces single-point failures of relying on any given classification technique by enabling redundant decision layers for validating classifications, thereby providing the technical benefit of reducing error propagation and increasing accuracy when classifying writing content excerpts via grouping. As discussed above, process 400 may be performed by a variety of decision tree-based models (or other machine learning models) implementable by a writing content classification system in accordance with illustrative aspects.

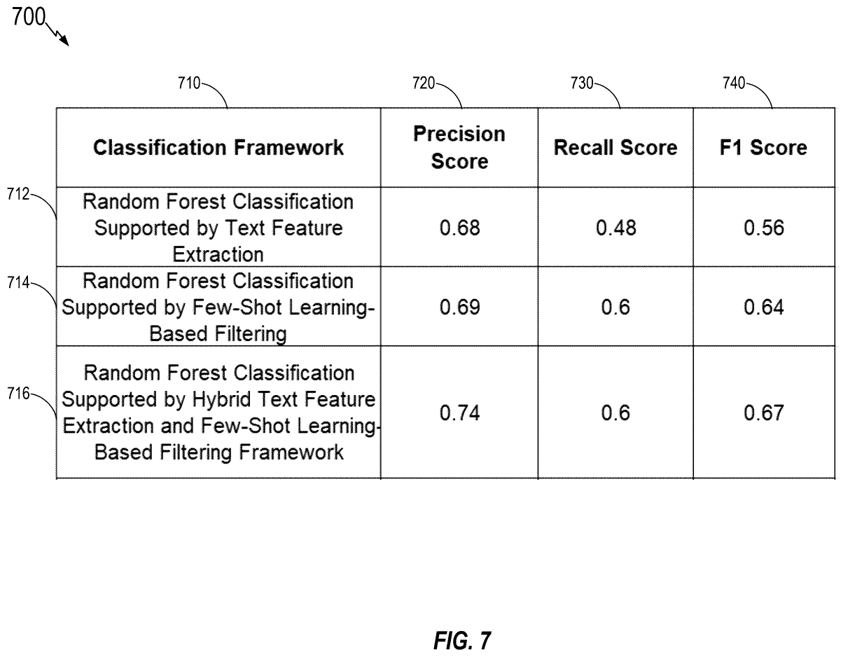

FIG. 7 depicts a table 700 comparing classification performance of different classification frameworks with a hybrid language model and random forest classification model framework implementable by a writing content classification system, such as described with respect to FIG. 1.

Column 710 of table 700 includes three different classification frameworks having corresponding performance data shown in table 700. A first classification framework 712 utilizes random forest classification supported only by text feature extraction, such as using extracted sets of linguistic features, for example, using similar means as discussed at block 210 of process 200 described above with reference to FIG. 2, and block 414 of process 400 described above with reference to FIG. 4. A second classification framework 714 utilizes random forest classification supported only by few-shot learning-based filtering, such as using labeled writing content excerpts having associated binary feature labels. For example, the binary feature labels used by second classification framework 714 could be obtained using similar means as discussed at block 206 of process 200 described above with reference to FIG. 2 or blocks 408-410 of process 400 described above with reference to FIG. 4. A third classification framework 716 utilizes a random forest classification supported by a hybrid framework including text feature extraction and few-shot learning-based filtering techniques in accordance with writing content classification systems described herein. For example, third classification framework 716 may perform methods in accordance with process 400 described above with reference to FIG. 4 to classify writing content excerpts.

The performance of classification frameworks 712, 714, and 716 are evaluated based on a precision score, a recall score, and an F1 score.

Column 720 includes precision scores for each of the aforementioned classification frameworks. As used herein, the “precision score” refers to a measurement of the accuracy of the positive predictions made by a given classification framework being evaluated, such as based on calculating a ratio of the writing content excerpts correctly classified into a given grouping (also referred to as “true positives”) to the sum of the writing content excerpts correctly classified into groupings and the sentences incorrectly classified into a grouping (also referred to as “false positives”). For example, a classification framework may correctly classify nine writing content excerpts as true positives that belong to the group into which they were classified and may incorrectly classify one writing content excerpt as a false positive that was incorrectly classified as belonging to an incorrect grouping. Accordingly, the precision score for the classification framework would be the ratio of the nine true positives, divided by the sum of the nine true positives, and the one false positive, thereby obtaining a precision score of 0.9. Column 720 demonstrates that a classification framework utilizing a hybrid framework in accordance with described aspects was associated with an increased precision score as compared to the other evaluated classification frameworks.

Column 730 includes recall scores for each of the aforementioned classification frameworks. As used herein, a “recall score” refers to a measurement of how well a given model or classification framework correctly identifies all writing content excerpts that actually belong to a certain grouping, such as based on a calculated ratio of a number of true positives divided by the sum of the true positives and a number of sentences that belong to a target group but were classified into a different group (also referred to as “false negatives”). For example, if a classification framework accurately groups three writing content excerpts into a group “A” (three true positives), and misses one sentence that should have been accurately classified into group “A” (one false negative), then the recall for the classification framework would calculated by dividing the 3 true positives by the sum of the three true positives and the one false negative, thereby obtaining a recall score of 0.75. Column 730 demonstrates that a classification framework utilizing a hybrid framework in accordance with described aspects was associated with an increased recall score as compared to a random forest classification framework supported only by extracted linguistic features.

Column 740 includes F1 scores for each of the aforementioned classification frameworks. As used herein, an “F1 score” refers to a metric which balances the precision scores and recall scores as described above, such as by calculating 2×((Precision*Recall)/(Precision+Recall)). Column 740 demonstrates that a classification framework utilizing a hybrid framework in accordance with described aspects was associated with an increased F1 score as compared to the other evaluated classification frameworks. This indicates that described aspects are simultaneously associated with improved performance in both precision and recall.

### Example Method for Classifying Writing Content Using a Hybrid Classification Framework

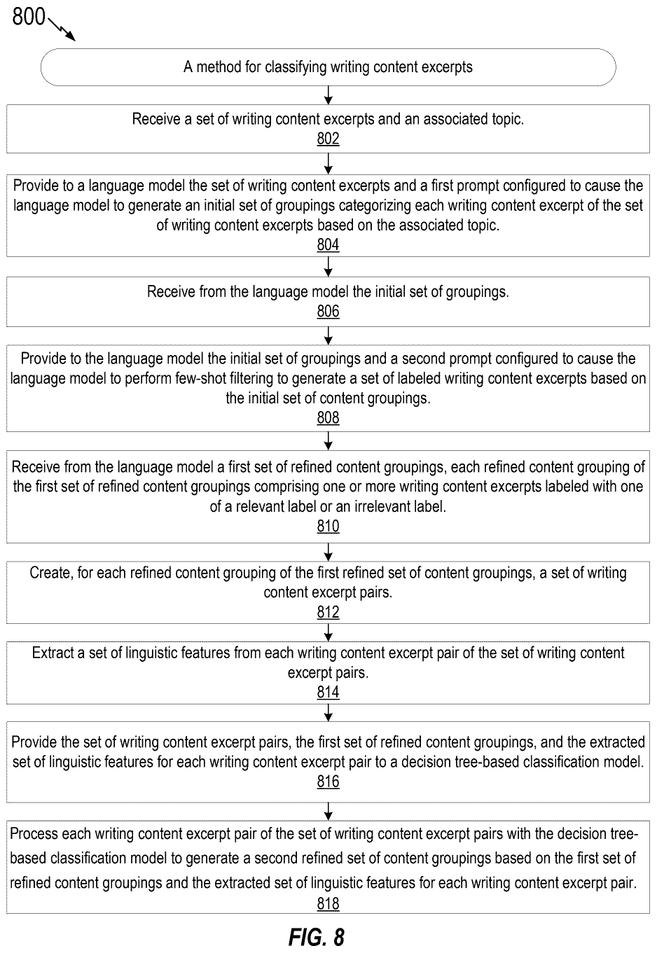

FIG. 8 depicts an example method 800 for classifying writing content using a hybrid language model and decision tree-based framework according to one or more aspects.

Method 800 begins at block 802 with receiving a set of writing content excerpts and an associated topic. For example, block 802 may be performed by the one or more processing systems 900 described below with reference to FIG. 9, configured to implement components including, but not limited to, a receiving component 921. As another example, block 802 may be performed by an input receiver component 112 described above with reference to FIG. 1 for performing corresponding processes, for example, corresponding to block 202 of process 200 described above with reference to FIG. 2 and block 402 of process 400 described above with reference to FIG. 4.

Method 800 proceeds to block 804 with providing to a language model the set of writing content excerpts and a first prompt configured to cause the language model to generate an initial set of content groupings categorizing each writing content excerpt of the set of writing content excerpts based on the associated topic. For example, block 804 may be performed by the one or more processing systems 900 described below with reference to FIG. 9, configured to implement components including, but not limited to, a providing component 922. As another example, block 804 may be performed by a prompt generator component 114 described above with reference to FIG. 1 for performing corresponding processes, for example, corresponding to block 204 of process 200 described above with reference to FIG. 2 and block 404 of process 400 described above with reference to FIG. 4.

Method 800 proceeds to block 806 with receiving from the language model the initial set of content groupings. For example, block 802 may be performed by the one or more processing systems 900 described below with reference to FIG. 9, configured to implement components including, but not limited to, a receiving component 921. As another example, block 806 may be performed by a prompt generator component 114 described above with reference to FIG. 1 for performing corresponding processes, for example, corresponding to block 202 of process 200 described above with reference to FIG. 2 and block 406 of process 400 described above with reference to FIG. 4.

Method 800 proceeds to block 808 with providing to the language model the initial set of content groupings and a second prompt configured to cause the language model to perform few-shot filtering to generate a set of labeled writing content excerpts based on the initial set of content groupings. For example, block 808 may be performed by the one or more processing systems 900 described below with reference to FIG. 9, configured to implement components including, but not limited to, a providing component 922. As another example, block 808 may be performed by an prompt generator component 114 described above with reference to FIG. 1 for performing corresponding processes, for example, corresponding to block 206 of process 200 described above with reference to FIG. 2 and block 408 of process 400 described above with reference to FIG. 4.

Method 800 proceeds to block 810 with receiving from the language model a first set of refined content groupings, each refined content grouping of the first set of refined content groupings comprising one or more writing content excerpts labeled with one of a relevant label or an irrelevant label. For example, block 802 may be performed by the one or more processing systems 900 described below with reference to FIG. 9, configured to implement components including, but not limited to, a receiving component 921. As another example, block 810 may be performed by a prompt generator component 114 described above with reference to FIG. 1 for performing corresponding processes, for example, corresponding to block 206 of process 200 described above with reference to FIG. 2 and block 410 of process 400 described above with reference to FIG. 4.

Method 800 proceeds to block 812 with creating, for each refined content grouping of the first refined set of content groupings, a set of writing content excerpt pairs. For example, block 812 may be performed by the one or more processing systems 900 described below with reference to FIG. 9, configured to implement components including, but not limited to, a creating component 923. As another example, block 812 may be performed by an excerpt pair creator component 120 described above with reference to FIG. 1 for performing corresponding processes, for example, corresponding to block 208 of process 200 described above with reference to FIG. 2 and block 412 of process 400 described above with reference to FIG. 4.

Method 800 proceeds to block 814 with extracting a set of linguistic features from each writing content excerpt pair of the set of writing content excerpt pairs. For example, block 814 may be performed by the one or more processing systems 900 described below with reference to FIG. 9, configured to implement components including, but not limited to, an extracting component 924. As another example, block 802 may be performed by a linguistic feature extractor component 122 described above with reference to FIG. 1 for performing corresponding processes, for example, corresponding to block 210 of process 200 described above with reference to FIG. 2 and block 414 of process 400 described above with reference to FIG. 4.

Method 800 proceeds to block 816 with providing the set of writing content excerpt pairs, the first set of refined content groupings, and the extracted set of linguistic features for each writing content excerpt pair to a decision tree-based classification model. For example, block 816 may be performed by the one or more processing systems 900 described below with reference to FIG. 9, configured to implement components including, but not limited to, a providing component 922. As another example, block 816 may be performed by one or more of a prompt generator component 114, excerpt pair creator component 120, and linguistic feature extractor component 122 described above with reference to FIG. 1 for performing corresponding processes, for example, corresponding to block 416 of process 400 described above with reference to FIG. 4.

Method 800 proceeds to block 818 with processing each writing content excerpt pair of the set of writing content excerpt pairs with the decision tree-based classification model to generate a second refined set of content groupings based on the first set of refined content groupings and the extracted set of linguistic features for each writing content excerpt pair. For example, block 818 may be performed by the one or more processing systems 900 described below with reference to FIG. 9, configured to implement components including, but not limited to, a processing component 925. As another example, block 818 may be performed by classification model 124 described above with reference to FIG. 1 for performing corresponding processes, for example, corresponding to block 418 of process 400 described above with reference to FIG. 4.

In some aspects, the first prompt further includes instructions for causing the language model to generate the initial set of content groupings based on semantic similarities between a central idea conveyed by each of the writing content excerpts of the set of writing content excerpts, wherein the initial set of content groupings comprises a configured number of groups.

In some aspects, the first prompt further includes instructions for causing the language model to label each content grouping of the initial set of content groupings based on the central idea conveyed by each of the writing content excerpts corresponding to each content grouping.

In some aspects, the set of writing content excerpts includes one or more of resume experience excerpts, job descriptions, or task descriptions.

In some aspects, the first prompt further includes instructions for causing the language model to: identify a labeled grouping of the initial set of content groupings that comprises a number of writing content excerpts exceeding a threshold; an divide the identified labeled grouping into two or more sub-groupings.

In some aspects, the first prompt is further configured to cause the language model to generate a group identifier and group name associated with each content grouping of the initial set of content groupings.

In some aspects, the set of extracted linguistic features includes a semantic similarity measurement, a length disparity measurement, and a Jaccard similarity measurement between respective writing content excerpts of each writing content excerpt pair from the set of writing content excerpt pairs.

In some aspects, the set of extracted linguistic features further includes a secondary semantic similarity measurement of a first sequential set of words between respective writing content excerpts of each writing content excerpt pair from the set of writing content excerpt pairs.

In some aspects, the decision tree-based classification model generates the second refined set of content groupings based on one or more thresholds associated with respective linguistic features of the set of extracted linguistic features.

In some aspects, the set of extracted linguistic features comprises a semantic similarity measurement between respective writing content excerpts of each writing content excerpt pair from the set of writing content excerpt pairs.

In some aspects, generating the second refined set of content groupings for each writing content excerpt pair includes labeling each respective writing content excerpt with a corresponding group identifier and a corresponding group name, wherein the corresponding group identifier and corresponding group name are selected from the initial set of content groupings.

In some aspects, generating of the second refined set of content groupings for each writing content excerpt pair further includes: identifying an individualized writing content excerpt that is labeled as irrelevant with respect to any existing grouping of the initial set of content groupings; and labeling the individualized writing content excerpt with an individualized grouping label.

Method 800 thus provides technical solutions to overcome shortcomings of conventional techniques for classifying writing content excerpts into distinct groupings. Method 800 classifies writing content excerpts with increased precision and recall based on considering contextual information while reducing language model-based false positives by further considering extracted linguistic features. Method 800 thus enables use of a hybrid framework that reduces single-point failures of relying on any given classification technique by enabling redundant decision layers for validating classifications, thereby providing the technical benefit of reducing error propagation and increasing accuracy when classifying writing content excerpts via grouping.

FIG. 8 is just one example of a method, and other methods including fewer, additional, or alternative steps are possible consistent with this disclosure.

### Example Processing System for Classifying Writing Content Using a Hybrid Classification Framework

FIG. 9 depicts an example processing system 900 upon which one or more aspects shown and described herein may be implemented.

The processing system 900 includes one or more processors 902. Generally, processor(s) 902 may be configured to execute computer-executable instructions (e.g., software code) to perform various functions, as described herein.

The processing system 900 further includes a network interface(s) 904, which generally provides data access to any sort of data network, including personal area networks (PANs), local area networks (LANs), wide area networks (WANs), the Internet, and the like.

The processing system 900 further includes input(s) and output(s) 906, which generally provide means for providing data to and from the processing system 900, such as via connection to computing device peripherals, including user interface peripherals.

The processing system 900 further includes one or more memories 910. Memory(s) 910 are configured to store various types of components and data.

In this example, memory 910 includes a receiving component 921, a providing component 922, a creating component 923, an extracting component 924, a processing component 925, and a generating component 926.

Receiving component 921 may be configured to perform processes, for example, corresponding to blocks 802, 806, and 810 of method 800 described above with reference to FIG. 8. Receiving component 921 may further be configured to perform processes, for example, corresponding to block 202 of process 200 described above with reference to FIG. 2 and blocks 402, 406, 410, and 420 of process 400 described above with reference to FIG. 4.

Providing component 922 may be configured to perform processes, for example, corresponding to blocks 804, 808, 816 of method 800 described above with reference to FIG. 8. Providing component 922 may further be configured to perform processes, for example, corresponding to block 204, 206, and 216 of process 200 described above with reference to FIG. 2 and blocks 404 and 408 of process 400 described above with reference to FIG. 4.

Creating component 923 may be configured to perform processes, for example, corresponding to block 812 of method 800 described above with reference to FIG. 8. Creating component 923 may further be configured to perform processes, for example, corresponding to block 208 of process 200 described above with reference to FIG. 2 and block 412 of process 400 described above with reference to FIG. 4.

Extracting component 924 may be configured to perform processes, for example, corresponding to block 814 of method 800 described above with reference to FIG. 8. Extracting component 924 may further be configured to perform processes, for example, corresponding to block 210 of process 200 described above with reference to FIG. 2 and block 414 of process 400 described above with reference to FIG. 4.

Processing component 925 may be configured to perform processes, for example, corresponding to block 818 of method 800 described above with reference to FIG. 8. Processing component 925 may further be configured to perform processes, for example, corresponding to block 418 of process 400 described above with reference to FIG. 4.

In this example, memory 910 also includes linguistic algorithms 940, embedding algorithms 941, prompt template data 942, and training data 943.

The processing system 900 may be implemented in various ways. For example, the processing system 900 may be implemented within on-site, remote, or cloud-based computing devices.

The processing system 900 is just one example, and other configurations are possible. For example, in alternative aspects, aspects described with respect to the processing system 900 may be omitted, added, or substituted for alternative aspects.

### EXAMPLE CLAUSES

Implementation examples are described in the following numbered clauses:

Clause 1: A method for classifying writing content excerpts, the method comprising: receiving a set of writing content excerpts and an associated topic; providing to a language model the set of writing content excerpts and a first prompt configured to cause the language model to generate an initial set of content groupings categorizing each writing content excerpt of the set of writing content excerpts based on the associated topic; receiving from the language model the initial set of content groupings; providing to the language model the initial set of content groupings and a second prompt configured to cause the language model to perform few-shot filtering to generate a set of labeled writing content excerpts based on the initial set of content groupings; receiving from the language model a first set of refined content groupings, each refined content grouping of the first set of refined content groupings comprising one or more writing content excerpts labeled with one of a relevant label or an irrelevant label; creating, for each refined content grouping of the first refined set of content groupings, a set of writing content excerpt pairs; extracting a set of linguistic features from each writing content excerpt pair of the set of writing content excerpt pairs; providing the set of writing content excerpt pairs, the first set of refined content groupings, and the extracted set of linguistic features for each writing content excerpt pair to a decision tree-based classification model; and processing each writing content excerpt pair of the set of writing content excerpt pairs with the decision tree-based classification model to generate a second refined set of content groupings based on the first set of refined content groupings and the extracted set of linguistic features for each writing content excerpt pair.

Clause 2: The method of Clause 1, wherein the first prompt further comprises instructions for causing the language model to generate the initial set of content groupings based on similarities between a central idea conveyed by each writing content excerpt of the set of writing content excerpts, wherein the initial set of content groupings comprises a configured number of groups.

Clause 3: The method of Clause 2, wherein the first prompt further comprises instructions for causing the language model to label each content grouping of the initial set of content groupings based on the central idea conveyed by the writing content excerpts of each content grouping.

Clause 4: The method of any one of Clauses 1-3, wherein the set of writing content excerpts comprises one or more of resume experience excerpts, job descriptions, or task descriptions.

Clause 5: The method of any one of Clauses 1-4, wherein the first prompt further comprises instructions for causing the language model to: identify a labeled grouping of the initial set of content groupings that comprises a number of writing content excerpts exceeding a threshold; and divide the identified labeled grouping into two or more sub-groupings.

Clause 6: The method of any one of Clauses 1-5, wherein the first prompt is further configured to cause the language model to generate a group identifier and group name associated with each content grouping of the initial set of content groupings.

Clause 7: The method of any one of Clauses 1-6, wherein the set of extracted linguistic features comprises a semantic similarity measurement, a length disparity measurement, and a Jaccard similarity measurement between respective writing content excerpts of each writing content excerpt pair from the set of writing content excerpt pairs.

Clause 8: The method of any one of Clauses 1-7, wherein the set of extracted linguistic features further comprises a secondary semantic similarity measurement of a first sequential set of words between respective writing content excerpts of each writing content excerpt pair from the set of writing content excerpt pairs.

Clause 9: The method of any one of Clauses 1-8, wherein the decision tree-based classification model generates the second refined set of content groupings based on one or more thresholds associated with respective linguistic features of the set of extracted linguistic features.

Clause 10: The method of any one of Clauses 1-9, wherein the set of extracted linguistic features comprises a semantic similarity measurement between respective writing content excerpts of each writing content excerpt pair from the set of writing content excerpt pairs.

Clause 11: The method of any one of Clauses 1-10, wherein generating the second refined set of content groupings for each writing content excerpt pair comprises labeling each respective writing content excerpt with a corresponding group identifier and a corresponding group name, wherein the corresponding group identifier and corresponding group name are selected from the initial set of content groupings.

Clause 12: The method of any one of Clauses 1-11, wherein generating of the second refined set of content groupings for each writing content excerpt pair further comprises: identifying an individualized writing content excerpt that is labeled as irrelevant with respect to any existing grouping of the initial set of content groupings; and labeling the individualized writing content excerpt with an individualized grouping label

Clause 13: A method comprising: receiving a set of writing content excerpts and an associated topic; providing to a language model the set of writing content excerpts and a first prompt configured to cause the language model to generate an initial set of content groupings categorizing each writing content excerpt of the set of writing content excerpts based on the associated topic; receiving from the language model the initial set of content groupings; providing to the language model the initial set of content groupings and a second prompt configured to cause the language model to perform few-shot filtering to generate a set of labeled writing content excerpts based on the initial set of content groupings; receiving from the language model a first set of refined content groupings, each refined content grouping of the first set of refined content groupings comprising one or more writing content excerpts labeled with one of a relevant label or an irrelevant label; creating, for each refined content grouping of the first refined set of content groupings, a set of writing content excerpt pairs; extracting a set of linguistic features from each writing content excerpt pair of the set of writing content excerpt pairs; generating a set of training data comprising the first set of refined content groupings, the extracted set of linguistic features for each writing content excerpt pairs, and a set of manually labeled content groupings, wherein the manually labeled content groupings are based on the initial set of content groupings; and training a decision tree-based classification model with the set of training data, wherein the decision tree-based classification model is configured to determine a similarity prediction for input comprising a pair of writing content excerpts.

Clause 14: A processing system, comprising means for performing a method in accordance with any one of Clauses 1-13.

Clause 15: A non-transitory computer-readable medium comprising computer-executable instructions that, when executed by one or more processors of a processing system, cause the processing system to perform a method in accordance with any one of Clauses 1-13.

Clause 16: A computer program product embodied on a computer-readable storage medium comprising code for performing a method in accordance with any one of Clauses 1-13.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for classifying writing content excerpts, the method comprising:
receiving a set of writing content excerpts and an associated topic;
providing to a language model the set of writing content excerpts and a first prompt configured to cause the language model to generate an initial set of content groupings categorizing each writing content excerpt of the set of writing content excerpts based on the associated topic;
receiving from the language model the initial set of content groupings;
providing to the language model the initial set of content groupings and a second prompt configured to cause the language model to perform few-shot filtering to generate a set of labeled writing content excerpts based on the initial set of content groupings;
receiving from the language model a first set of refined content groupings, each refined content grouping of the first set of refined content groupings comprising one or more writing content excerpts labeled with one of a relevant label or an irrelevant label;
creating, for each refined content grouping of the first refined set of refined content groupings, a set of writing content excerpt pairs;
extracting a set of linguistic features from each writing content excerpt pair of the set of writing content excerpt pairs;
providing the set of writing content excerpt pairs, the first set of refined content groupings, and the extracted set of linguistic features for each writing content excerpt pair to a decision tree-based classification model; and
processing each writing content excerpt pair of the set of writing content excerpt pairs with the decision tree-based classification model to generate a second refined set of content groupings based on the first set of refined content groupings and the extracted set of linguistic features for each writing content excerpt pair.

2. The method of claim 1, wherein the first prompt further comprises instructions for causing the language model to generate the initial set of content groupings based on similarities between a central idea conveyed by each writing content excerpt of the set of writing content excerpts, wherein the initial set of content groupings comprises a configured number of groups.

3. The method of claim 2, wherein the first prompt further comprises instructions for causing the language model to label each content grouping of the initial set of content groupings based on the central idea conveyed by the writing content excerpts of each content grouping.

4. The method of claim 1, wherein the set of writing content excerpts comprises one or more of resume experience excerpts, job descriptions, or task descriptions.

5. The method of claim 1, wherein the first prompt further comprises instructions for causing the language model to:
identify a labeled grouping of the initial set of content groupings that comprises a number of writing content excerpts exceeding a threshold; and
divide the identified labeled grouping into two or more sub-groupings.

6. The method of claim 1, wherein the first prompt is further configured to cause the language model to generate a group identifier and group name associated with each content grouping of the initial set of content groupings.

7. The method of claim 1, wherein the set of extracted linguistic features comprises a semantic similarity measurement, a length disparity measurement, and a Jaccard similarity measurement between respective writing content excerpts of each writing content excerpt pair from the set of writing content excerpt pairs.

8. The method of claim 7, wherein the set of extracted linguistic features further comprises a secondary semantic similarity measurement of a first sequential set of words between respective writing content excerpts of each writing content excerpt pair from the set of writing content excerpt pairs.

9. The method of claim 1, wherein the decision tree-based classification model generates the second refined set of content groupings based on one or more thresholds associated with respective linguistic features of the set of extracted linguistic features.

10. The method of claim 1, wherein the set of extracted linguistic features comprises a semantic similarity measurement between respective writing content excerpts of each writing content excerpt pair from the set of writing content excerpt pairs.

11. The method of claim 6, wherein generating the second refined set of content groupings for each writing content excerpt pair comprises labeling each respective writing content excerpt with a corresponding group identifier and a corresponding group name, wherein the corresponding group identifier and corresponding group name are selected from the initial set of content groupings.

12. The method of claim 1, wherein generating of the second refined set of content groupings for each writing content excerpt pair further comprises:
identifying an individualized writing content excerpt that is labeled as irrelevant with respect to any existing grouping of the initial set of content groupings; and
labeling the individualized writing content excerpt with an individualized grouping label.

13. A processing system, comprising:
one or more memories comprising computer-executable instructions; and
one or more processors configured to execute the computer-executable instructions causing the processing system to:
receive a set of writing content excerpts and an associated topic;
provide to a language model the set of writing content excerpts and a first prompt configured to cause the language model to generate an initial set of content groupings categorizing each writing content excerpt of the set of writing content excerpts based on the associated topic;
receive from the language model the initial set of content groupings;
provide to the language model the initial set of content groupings and a second prompt configured to cause the language model to perform few-shot filtering to generate a set of labeled writing content excerpts based on the initial set of content groupings;
receive from the language model a first set of refined content groupings, each refined content grouping of the first set of refined content groupings comprising one or more writing content excerpts labeled with one of a relevant label or an irrelevant label;
create, for each refined content grouping of the first refined-set of refined content groupings, a set of writing content excerpt pairs;
extract a set of linguistic features from each writing content excerpt pair of the set of writing content excerpt pairs;
provide the set of writing content excerpt pairs, the first set of refined content groupings, and the extracted set of linguistic features for each writing content excerpt pair to a decision tree-based classification model; and
process each writing content excerpt pair of the set of writing content excerpt pairs with the decision tree-based classification model to generate a second refined set of content groupings based on the first set of refined content groupings and the extracted set of linguistic features for each writing content excerpt pair.

14. The processing system of claim 13, wherein the first prompt further comprises instructions for causing the language model to generate the initial set of content groupings based on similarities between a central idea conveyed by each of the writing content excerpts of the set of writing content excerpts, wherein the initial set of content groupings comprises a configured number of groups.

15. The processing system of claim 13, wherein the first prompt is further configured to cause the language model to generate a group identifier and group name associated with each content grouping of the initial set of content groupings.

16. The processing system of claim 13, wherein the set of extracted linguistic features comprises a semantic similarity measurement, a length disparity measurement, and a Jaccard similarity measurement between respective writing content excerpts of each writing content excerpt pair from the set of writing content excerpt pairs.

17. The processing system of claim 13, wherein the decision tree-based classification model generates the second refined set of content groupings based on one or more thresholds associated with respective linguistic features of the set of extracted linguistic features.

18. The processing system of claim 13, wherein the set of extracted linguistic features comprises a semantic similarity measurement between respective writing content excerpts of each writing content excerpt pair from the set of writing content excerpt pairs.

19. The processing system of claim 13, wherein to generate the second refined set of content groupings for each writing content excerpt pair, the processing system is further configured to label each respective writing content excerpt with a corresponding group identifier and a corresponding group name, wherein the corresponding group identifier and corresponding group name are selected from the initial set of content groupings.

20. A method, comprising:
receiving a set of writing content excerpts and an associated topic;
providing to a language model the set of writing content excerpts and a first prompt configured to cause the language model to generate an initial set of content groupings categorizing each writing content excerpt of the set of writing content excerpts based on the associated topic;
receiving from the language model the initial set of content groupings;
providing to the language model the initial set of content groupings and a second prompt configured to cause the language model to perform few-shot filtering to generate a set of labeled writing content excerpts based on the initial set of content groupings;
receiving from the language model a first set of refined content groupings, each refined content grouping of the first set of refined content groupings comprising one or more writing content excerpts labeled with one of a relevant label or an irrelevant label;
creating, for each refined content grouping of the first set of refined content groupings, a set of writing content excerpt pairs;
extracting a set of linguistic features from each writing content excerpt pair of the set of writing content excerpt pairs;
generating a set of training data comprising the first set of refined content groupings, the extracted set of linguistic features for each writing content excerpt pairs, and a set of manually labeled content groupings, wherein the manually labeled content groupings are based on the initial set of content groupings; and
training a decision tree-based classification model with the set of training data, wherein the decision tree-based classification model is configured to determine a similarity prediction for input comprising a pair of writing content excerpts.
